(19) United States
(12) Patent Application Publication
(10) Pub. No.: US 2018/0347546 A1
(43) Pub. Date: Dec. 6, 2018

(54) Unit for solar and wind energy utilisation

(71) Applicants: Waldemar Piskorz, Koden (PL); Tomasz Tadeusz Piskorz, Koden (PL); Ireneusz Piskorz, Koden (PL)

(72) Inventors: Waldemar Piskorz, Koden (PL); Tomasz Tadeusz Piskorz, Koden (PL); Ireneusz Piskorz, Koden (PL)

(21) Appl. No.: 15/778,435

(22) PCT Filed: Nov. 23, 2016
(86) PCT No.: PCT/IB2016/057054

§ 371 Date: May 23, 2018

(30) Foreign Application Priority Data
Nov. 24, 2015 (PL) P.414921

(51) Int. Cl. F03D 9/00; F03D 3/04; F03D 9/11; F03D 9/25; F03D 7/06; H02S 10/12; H02S 10/20

(52) U.S. Cl. CPC F03D 9/007; F03D 3/0418; F03D 3/0427; F03D 9/11; F05B 2220/708; F03D 7/06; H02S 10/12; H02S 10/20; F03D 9/255

(57) ABSTRACT

The goal of the invention is to maintain a constant supply of electrical energy with use of solar and wind power. According to the invention there is a generator and a first motor mounted on the shaft of the column, where said generator is connected, through a first relay and inverter with a power grid and the generator is also connected, through rectifier with a battery pack. Rotary guides, connected with second motors are covered with a layer with photovoltaic cells.

The subject of the invention is an unit for solar and wind energy utilisation, especially for power generation.

A wind turbine is known from document DE 102010008337, with construction and guide vanes covered with lacquer or with film with photovoltaic cells.

Wind turbine is also known from the Polish application P.411022, having a stationary housing with guide vanes and at least one wind guide, comprising comprises two rectangular wings fixed to a mounted shaft, connected to drive system, connected to control system.

A multisegment wind turbine is known from application WO2008121024, coupled rotors of which are connected to shaft on which a there is a generator connected to the power grid installed.

According to the invention there is a generator and a first electric motor mounted on the main shaft of the column with wind turbines. The generator is connected through a first relay and an inverter with a power grid, and the generator is connected, through a rectifier with a pack of batteries. Four rotary guides, connected with second electric motors designed for rotating the mentioned rotary guides, are covered with film with phtovoltaic solar cells.

Power outlet of photovoltaic cells on guides and photovoltaic cells on outer surfaces of wind turbines is electrically connected by a third relay with the first electric motor or by fourth relay with the inverter and further with an electric grid. On the top of the column there is a first wind sensor of wind speed and direction installed, and the second sensor following the sun, both connected electrically with a control system. The first relay, third relay, fourth relay and second motors of rotary guides are also connected to the control system.

The pack of batteries is electrically connected through the second relay and a converter with the power grid and with second electrical motors, where the second relay is connected electrically with the control system.

There are fairings covered with film with photovoltaic cells between the wind turbines.

The unit provides a continuous supply of electricity, especially for individual households or enterprises. In the case of absence of required wind speed or cloudness, the recipient can use electricity stored in the pack of batteries.

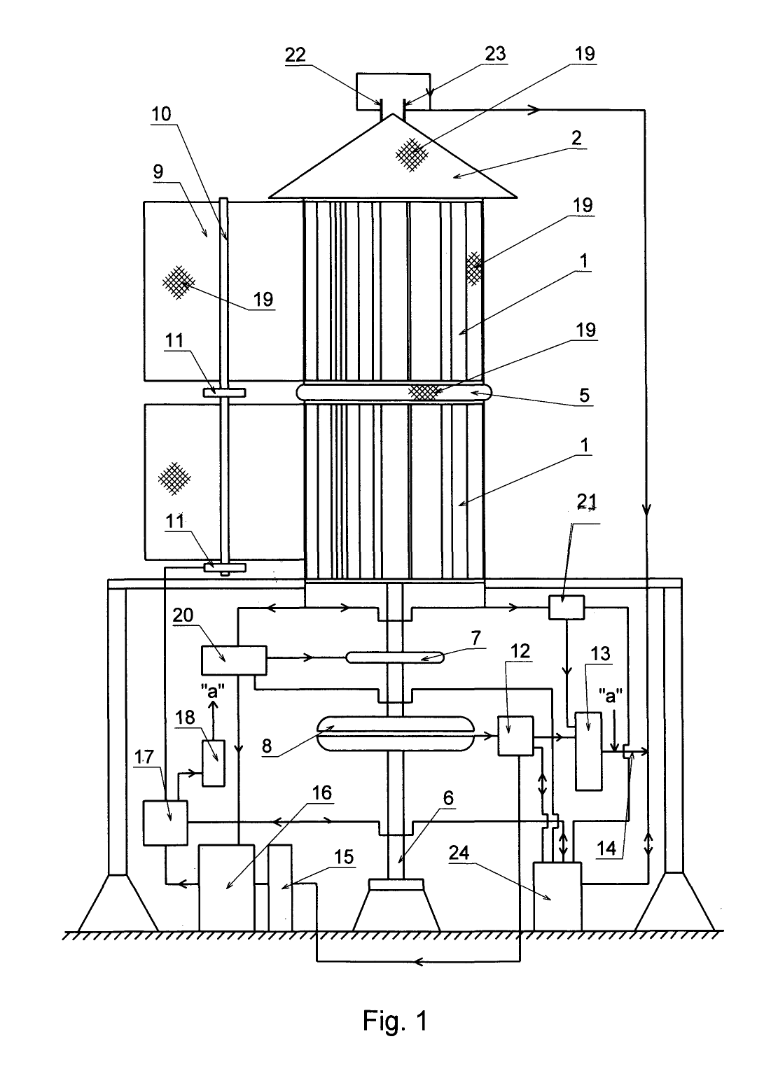

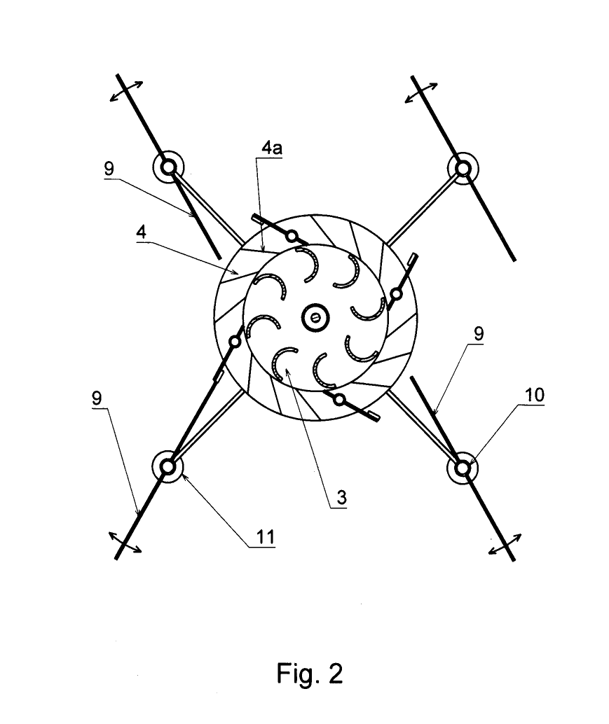

The subject matter of the invention is illustrated in the exemplary embodiment in drawings, where FIG. 1 shows the column with one guide and the block diagram of electrical connections, and FIG. 2 shows the cross-section of the unit with four guides.

The unit for wind and solar energy utilisation consists of two vertical axis wind turbines 1 covered with a roof 2. The wind turbine 1 is assembled with a rotor 3 and casing 4, said casing having guide vanes 4a. Between the wind turbines 1 there are fairings 5. On the shaft 6 of a column there is a first electric motor 7 and generator 8. Around the column there are rotary guides 9, masts 10 of said guides 9 are connected with second electric motors 11. Power outlet of the generator 8 is connected through the first relay 12 and inverter 13 with power grid 14, and is also connected via rectifier 15 with the battery pack 16, outlet of which is connected through a second relay 17 and converter 18 with the power grid 14, and with the second electric motors 11. The guide vanes 4a, roof 2, fairings 5 as well as rotary guides 9 are covered with foil 19 with photovoltaic cells wherein the guide vanes 4a are covered with foil 19 with photovoltaic cells on both sides. Power outlet of photovoltaic cells is connected through third relay 20 with the first electric motor 7, and with battery pack 16, and the outlet of photovoltaic cells is connected through fourth relay 21 and inverter 13 with the power grid 14. Relays 12, 17, 20 and 21, as well as a wind speed and direction sensor 22 and following sensor 23 are connected with the control system 24.

The first electric motor 7 is designed to start the wind turbines 1, and in case of strong wind there is a possibility to set it in such a way, so that it fulfills the functions of the generator. If the wind blows with proper speed, one guide 9 is set in the position, in which the wind pushes on its largest surface, and the three other guides 9 are set perpendicularly, in one plane, to the angle of the rays of sun. In case of lack of wind with proper speed, and good insolation, all rotary guides 9 are set towards the sun, and are the main source of power to the power grid 14. At the same time, if the generator 8 or photovoltaic cells generate electric current, the control system 24 provides total and constant charge of the battery pack 16.

1. A Unit for solar and wind energy utilisation, having a column with vertical axis wind turbines covered with foil with photovoltaic cells, also having generators connected with the main shaft of column and rotary guides, characterised in that on the shaft of the column there is a generator and a first electric motor installed, wherein the generator is connected through a first relay and an inverter with a power grid, and the generator connected through a rectifier a battery pack, and the rotary guides, connected with second motors are covered with a layer with photovoltaic cells, and the power outlet of mentioned photovoltaic cells and of the photovoltaic cells on the wind turbines is connected electrically through a third relay with the first electric motor or through a fourth relay with the inverter and further with the power grid, and the column is also equipped with a first wind speed and direction sensor and a second following sensor connected electrically with a control system, coupled with the first relay, third relay, fourth relay and second motors of the rotary guides.

2. The unit according to claim 1 characterised in that the battery pack is connected electrically through a second relay and a converter with the power grid and with the second electric motors, wherein the second relay is connected electrically with the control system.

3. The unit according to claim 1 characterised in that between the wind turbines there is a fairing, covered with the layer with photovoltaic cells.
